(19) United States
(12) Patent Application Publication
(10) Pub. No.: US 2005/0108631 A1
(43) Pub. Date: May 19, 2005

(54) Method of conducting data quality analysis

(76) Inventors: Antonio C. Amorin, Barrington, IL (US); Gary L. Figgins, Spring, TX (US)

Correspondence Address: MCANDREWS HELD & MALLOY, LTD, 500 WEST MADISON STREET, SUITE 3400, CHICAGO, IL, 60661, US

(21) Appl. No.: 10/953,728

(22) Filed: Sep. 29, 2004

Related U.S. Application Data
(60) Provisional application No. 60/506,893, filed on Sep. 29, 2003.

(51) Int. Cl. G06F 17/00

(52) U.S. Cl. 715/513

(57) ABSTRACT

A method for creating a data quality report for a given set of source data. The source data is profiled and then analysis is preferably performed at the relation level, metadata level, and data content level analysis. Any inconsistencies noted during analysis are noted with quality tags preferably comprising a common status and a type describing the category of the identified inconsistency. Reports are then generated that describe and summarize the information contained in the quality tags created during the analysis.

### CROSS-REFERENCE TO RELATED APPLICATION

This application claims the benefit of U.S. Provisional Application No. 60/506,893 entitled “Method for Conducting Data Quality Analysis,” filed on Sep. 29, 2003, having inventors Antonio Cesar Amorin and Gary Lee Figgins, which is incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### BACKGROUND OF THE INVENTION

The present invention relates to data profiling and data quality assessment of data sources such as flat file data sources and relational data sources.

IT projects often require data sourcing from disparate data sources that must be integrated before the data can be used in applications such as data warehouses, business intelligence and analytics, customer relationship management, enterprise resource planning, supply chain management, and electronic data interchange. Data integration projects are often time consuming, labor intensive efforts that experience problems due to inaccurate or incomplete understanding of the source data. A process known as data profiling can be used to define the content, structure and quality of the source data to identify inconsistencies and incompatibilities between the data sources and the target applications. Several products, including the Evoke Axio Product Suite™ and the Ascential Enterprise Integration Suite™, have been developed to allow IT personnel to conduct data profiling and thus significantly reduce the rework that is often involved with data sourcing efforts.

Even with the advantages provided by the data profiling products mentioned above, time and resources are often wasted through disorganization of the data profiling effort. The present invention is a tool for obtaining an assessment of the content, metadata, and structure of data sources and target applications in order to obtain the information necessary to properly plan a data profiling effort.

### BRIEF SUMMARY OF THE INVENTION

Various aspects of the present invention can be used to perform data quality analysis on data from any industry and source application whether relational, transaction based, real-time, pseudo-conversational, or conversational. The invention is intended to perform data quality assessments using data profiling software. The output from the data quality assessments is intended for use in managing data profiling efforts, estimating the amount of time necessary to perform detailed analysis, identifying problem attributes and identifying possible transformation rules for the data.

The present invention is useful in identifying potential file structure, metadata, and data content quality problems. The present invention provides a method for creating a data quality report for a given set of source data by profiling the source data and then performing relation, metadata, and data content analysis, while noting inconsistencies with quality tags. Then, based on the quality tags, reports that make up the data quality reports are generated.

These and other advantages and novel features of aspects of the present invention, as well as details of an illustrated embodiment thereof, will be more fully understood from the following description and drawings.

### BRIEF DESCRIPTION OF SEVERAL VIEWS OF THE DRAWINGS

FIG. 1 is a flow-chart diagram illustrating a method of performing data quality analysis.

FIG. 2 is a flow-chart diagram illustrating a method for performing relation analysis.

FIGS. 3A and 3B are flow-chart diagrams illustrating a method for performing metadata analysis.

FIGS. 4A, 4B and 4C are flow-chart diagrams illustrating a method for performing data content analysis.

FIG. 5 a flow-chart diagram illustrating a method for generating reports.

FIG. 6 is one embodiment of a project data quality report, containing sample information, formatted to provide an overview of the data quality problems identified across an entire project.

FIG. 7 is one embodiment of a project metadata report, containing sample information, formatted to provide an overview of the file and metadata problems across an entire project.

FIG. 8 is one embodiment of a relational report, containing sample information, which provides a summary of the number of data quality, metadata, and file problems found for specific relations.

### DETAILED DESCRIPTION OF THE INVENTION

Aspects of the present invention comprise a methodology for utilizing data profiling software for performing a data quality assessment of flat file or relational data sources. Data sources are not restricted to a specific industry (such as financial, manufacturing, healthcare, etc) or computer platform (such as mainframe, Windows, UNIX, etc). In the preferred embodiment of the present invention, a step-by-step process is provided for evaluating the results of data profiling to identify potential file structure, metadata, and data content quality problems.

Aspects of the present invention utilize the profilers and primary components of an existing data profiling product, preferably the Evoke Axio Product Suite™. Custom components are then added to setup the environment for performing the novel methodology of the present invention. These components include: configuration files containing quality tags of specific status and specific type that will be utilized in performing the methodology of the present invention; scripts that need to be executed against the repository of the data profiling product, scripts containing the insert statements to include the unique quality types and status and containing create view statements to build the views required by the reports generated by the methodology of the present invention; and custom reports which are used to quantify and identify data quality exposures at a project, table/file, and attribute level and thus summarize the assessment that results from performing the methodology of the present invention.

The preferred embodiment of the invention utilizes a combination of custom configuration files for the Evoke Software Axio Server™, custom RDBMS scripts for the Evoke Repository™, and custom reports created in Crystal Reports™. The two configuration files are integrated into the default Axio Server™ configuration files to establish specific Action Item Tag™ types and status. The two scripts contain SQL to insert the new types and status into the Evoke Repository™ and create views against the Evoke Repository™ tables to summarize data for the custom reports. The six custom reports execute against the Evoke Repository™ to summarize the results and create data quality reports.

Once the environment for performing the novel methodology of the present invention is in place, the methodology can be performed. It is preferable, although not necessary, to first use an IROB file to create a new catalog in order to keep the reports generated as a result of performing the methodology of the present invention separate from other analyses performed by the data profiling software. Whether or not a new catalog is created, the source data must be profiled before the preferred analysis of the present invention can be performed.

According to the preferred methodology of the present invention, analysis is performed first at the metadata level and then at the data content level. More preferably, relation level analysis is performed prior to analyzing other aspects of metadata in order to avoid having relation level problems affect analysis of the other metadata and the data content. For the purposes of this description, therefore, relation level analysis is referred to separately from metadata analysis even though one of ordinary skill would understand that relation data is a form of metadata. The preferred embodiment of the present invention thus has three levels of analysis performed in the following sequence: relation level analysis, metadata level analysis and data content level analysis.

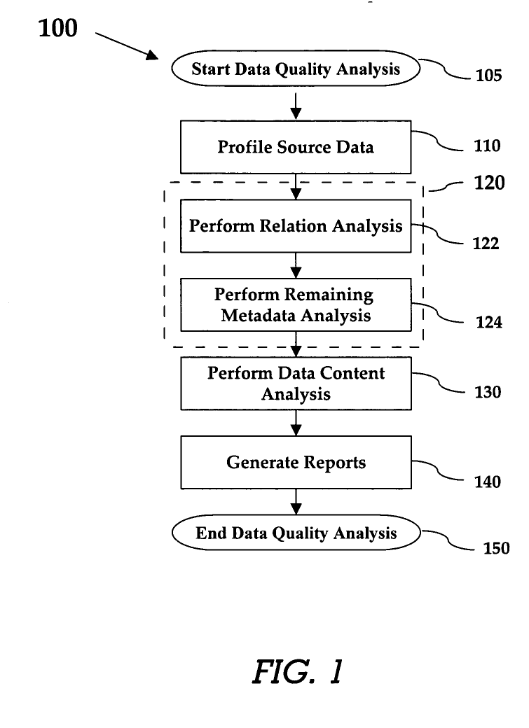

FIG. 1 is a flow chart diagram illustrating a method of performing data quality analysis 100. The start of the data quality analysis 105 continues to Block 110 wherein the source data is profiled. After the source data is profiled at Block 110, metadata analysis is performed at Block 120. In the preferred embodiment, relation analysis is performed at Block 122 and then remaining metadata analysis is performed at Block 124. Once the metadata analysis is completed as shown at Block 120, data content analysis is performed at Block 130. The illustrated method then moves on to generate reports at Block 140 wherein reports are generated to describe the results of the analysis. Once reports are generated the illustrated method is complete at Block 150.

In the preferred embodiment, analysis is performed by reviewing attributes and tagging the reviewed attributes with a quality tag to indicate that the data was reviewed. When the methodology of the present invention is used with Evoke Axio Product Suite™, the quality tags are preferably customized Action Item Tags™. Quality tags preferably have categorical designations comprising a status and a type. While the status and type of each quality tag can be customized for each project, the quality tags created during the methodology of the present invention preferably all have a common status indicator. The reports generated as a result of performing the analysis of the preferred embodiment are designed to describe the information contained only in quality tags having the chosen common status. The type used for each quality tag should indicate the category of any quality problems that were identified. The content of the quality tags preferably indicates who created the tag, the date and time that the tag was created, a description of the problem found, and example data.

Preferred quality tags for each level of analysis are contained in the following table. The first column of the table indicates the level of analysis during which the quality tag would preferably be used. The second column gives the status and type of the quality tag. Because any status indicator can be chosen, the indicator “SI” (for “status indicator”) is used herein as an example. The third column contains a description of the purpose and use of each preferred quality tag.

| Level of | Tag Status and | |
|---|---|---|
| Analysis | Type | Description |
| Relation | SI-Record Format | This type is used to identify |
| | | record formatting problems |
| | | with a flat file. Example |
| | | problems include mismatches |
| | | between the layout and the |
| | | content or problems with field |
| | | delimiters, etc. |
| Relation | SI-Mixed Encoding | This type is used to identify |
| | | mixtures of ASCII and |
| | | EBCDIC data. |
| Metadata | SI-Key Structure | This type is used to identify |
| | | situations where the data does |
| | | not support the identified key |
| | | structure for either files or |
| | | relational sources. |
| Metadata | SI-Referential | This type is used to identify |
| | Integrity | situations where the data does |
| | | not support the expected |
| | | referential integrity. |
| Metadata | SI-Null Rule | This type is used to identify |
| | | when the null rule is not |
| | | supported by the data. |
| Metadata | SI-Data Type | This type is used to identify |
| | | when the data does not |
| | | support the documented data |
| | | type. |
| Metadata | SI-Length | This type is used to identify an |
| | | unsupported length |
| | | associated with a data type. |
| Metadata | SI-Unused | This type is used to identify an |
| | | unused attribute. |
| Metadata | SI-Constant | This type is used to identify an |
| | | attribute that is constant |
| | | (contains a single value). |
| Metadata | SI-Metadata | This type is used to indicate |
| | Reviewed | that no metadata problems |
| | | were identified for the |
| | | attribute. |
| Data | SI-Data Reviewed | This type indicates that the |
| | | data was reviewed and no |
| | | obvious problems were |
| | | identified. |
| Data | SI-Test Data | This type indicates that the |
| | | data may contain test or |
| | | garbage data. |
| Data | SI-Mixed | This type indicates that the |
| | Alpha/Numeric | data for an attribute includes |
| | | an unusual mixture of alpha |
| | | and numeric data. |
| Data | SI-Mixed Date | This type indicates that there |
| | Pattern | are multiple date patterns for a |
| | | date field. |
| Data | SI-Mixed Content | This type indicates that data |
| | | appears to contain content |
| | | with completely different |
| | | meanings. |
| Data | SI-Mixed Pattern | This type indicates that there |
| | | are unusual or inconsistent |
| | | patterns for an attribute. |
| Data | SI-Data Exception | This type indicates that the |
| | | data includes items that may |
| | | cause data exceptions if used |
| | | in programs (such as having |
| | | alpha data in a numeric type |
| | | field that may be used for |
| | | calculations). |
| Data | SI-Duplicate Data | This type indicates that there |
| | | is data duplication, such as |
| | | “Data Innovations”, “Data |
| | | Innovations, Inc.”, or “Data |
| | | Innovation”. Another example |
| | | would be “a”, “A”, “a”, etc. |
| Data | SI-Mixed Case | This type indicates that the |
| | | case is unusually mixed in the |
| | | data. |
| Data | SI-Range Error | This type indicates that there |
| | | is an unusual range for an |
| | | attribute. An example would |
| | | be a gender indicator |
| | | containing the following value |
| | | frequencies: “M”, “F”, “U”, |
| | | “G”, “X”, etc. |
| Data | SI-Invalid Lookup | This type indicates that there |
| | Values | are items not contained in a |
| | | lookup table. The intention |
| | | here is to identify problems |
| | | with the data, not just the |
| | | referential integrity. |

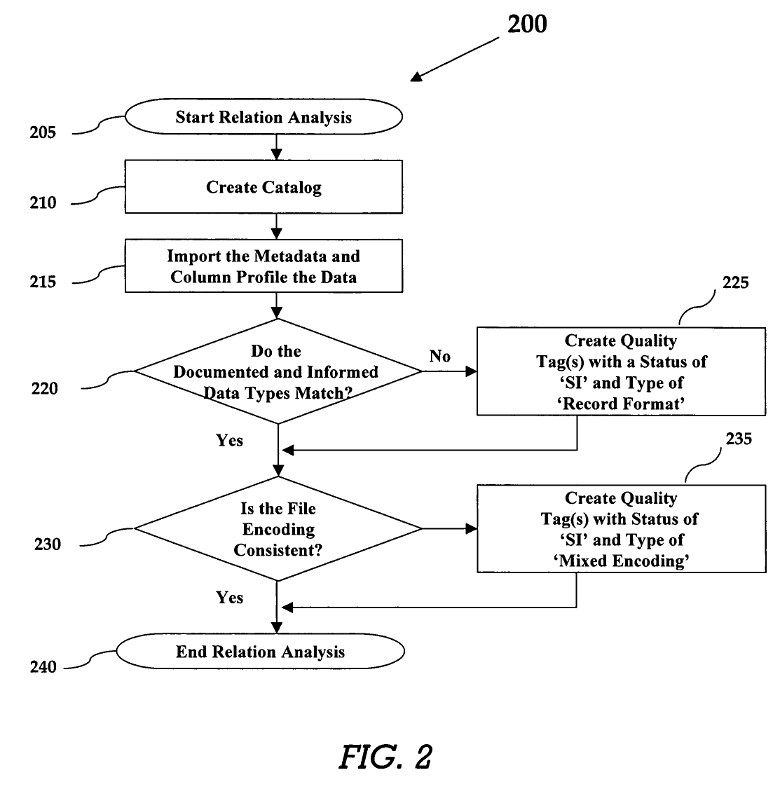

FIG. 2 is a flow chart diagram illustrating a preferred method of performing relation level analysis 200 utilizing the appropriate preferred quality tags from the table above. Relation level analysis usually does not need to be performed on relational data sources because they are generally in good condition because of the nature of the RDBMS. Flat file data sources, however, can have a number of different problems including record format and mixed encoding problems. The illustrated method starts at Block 205 and continues to Block 210 wherein a catalog is created for the project. From Block 210, the method continues to Block 215 wherein the metadata is imported and the data is column profiled. The method then continues to Block 220 wherein the documented and inferred data types are examined to determine whether they match. When there are significant differences with the documented and inferred data types, this is an indication that there are either record format problems or that the documented metadata does not match the data. Such problems are often associated with flat file data sources and can be found by opening the attribute list viewer for the relation and comparing the documented and inferred data types for each attribute from top to bottom. If the documented and inferred data types do not match, the method continues to Block 225 wherein a quality tag is created with the common status “SI” and the preferred type “Record Format.”

After quality tags are created for any record format problems found at Block 225, or after it is determined that the documented and inferred data types do match in Block 220, the illustrated preferred method continues to Block 230 wherein the encoding is examined to determine whether it is consistent. Encoding discrepancies may arise because the data profiling software with which the present invention is used is designed to handle either EBCDIC or ASCII, but not both in the same file or record. Encoding problems are easily identifiable when the minimum and maximum values are reviewed to see if there are values that indicate a mixture of EBCDIC and ASCII. When an encoding problem exists, the data will contain items that are not usable. If encoding problems are found, the preferred method continues to Block 235 wherein a quality tag is created with the common status “SI” and the preferred type “Mixed Encoding.” If there are no encoding discrepancies found during the analysis at Block 230, or once quality tags describing found encoding discrepancies are created at Block 235, the preferred relation analysis ends at Block 240.

Once the relation analysis has been completed, and any problems have been noted with the appropriate quality tags, it is preferable to use the where clause to exclude records with format problems before moving on in order to prevent the format problems from interfering with the metadata and data analysis.

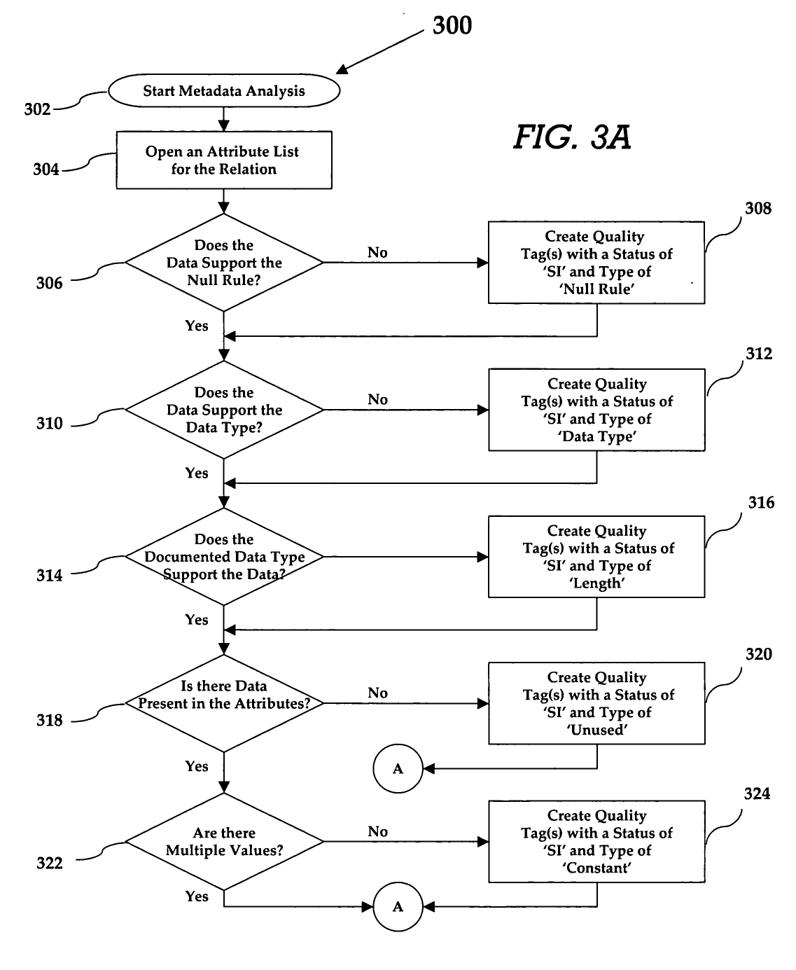

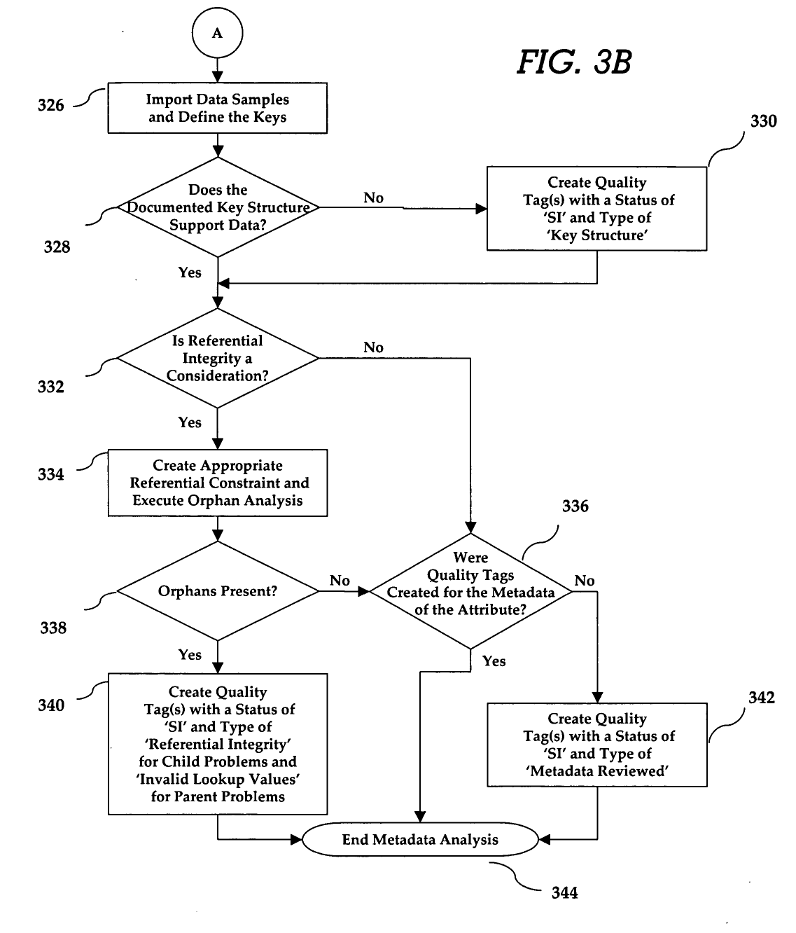

FIGS. 3A and 3B are flow chart diagrams describing a preferred method for performing metadata analysis. The purpose of this analysis is to review the basic metadata to ensure that the metadata accurately describes the data. In the preferred embodiment of the present invention, several aspects of the metadata are specifically reviewed and any problems found are noted with the appropriate quality tags as listed in the table above. It is not necessary that the specific metadata aspects be reviewed in the order in which they are described in FIGS. 3A and 3B.

The illustrated method starts at Block 302 and continues to Block 304 wherein an attribute list is opened so that the aspects of the metadata can be reviewed. From Block 304, the illustrated method continues to Block 306 wherein analysis is performed to determine whether the data supports the null rule. The documented null rule for each attribute should be reviewed to verify that the rule matches the profiling results in the attribute list viewer. The null rule is not usually a problem for relational data sources, but, for example, it is possible that the documentation could become dated over time and the null rule might change to support new business rules. If the data does not support the null rule, the method continues to Block 308 wherein quality tags are created with the common status “SI” and the preferred type “Null Rule.”

If the data is found to support the null rule at Block 306, or once appropriate quality tags are created at Block 308, the method continues to Block 310 wherein the data type is examined to determine whether the documented data type supports the data. For example, a documented data type of “decimal” and an inferred data type of “character” indicates a problem where the metadata does not support the data. If the documented data type does not support the data, the method continues to Block 312 wherein a quality tag is created with the common status “SI” and the preferred type “Data Type.”

If the documented data type is found to support the data at block 310, or after appropriate quality tags are created at Block 312, the illustrated method continues to Block 314 wherein the data type length is examined to determine whether the documented data type length supports the data. For example, a documented data type of CHAR(10) and an inferred data type of CHAR(15) would indicate that five bytes of character data could be lost or incorrectly appended into the following attribute during the ETL process for a flat file. If the data type length does not support the data, the illustrated method continues to Block 316 wherein a quality tag is created for any data type length problems identified with the common status “SI” and the type “Length.”

If the documented data type length is found to support the data at block 314, or after appropriate quality tags are created at Block 316, the illustrated method continues to Block 318 wherein it is determined whether there is data present in each of the attributes. This determination can be made within the attribute list viewer by sorting the number of distinct columns and noting the attributes that contain a zero (0) for the number of distinct columns. If there are attributes containing no data, the illustrated method continues to Block 320 wherein a quality tag is created to describe the unused attribute with the common status “SI” and the preferred type “Unused.” If there are no attributes for which data is present, the illustrated method continues from Block 320 to the cross-reference indicator A and from there to FIG. 3B.

For any attributes for which data is found to be present in the analysis at Block 318, then the illustrated method continues to Block 322 wherein it is determined whether the data has multiple values. Whether an attribute is constant, rather than having multiple values, can be identified within the attribute list viewer by sorting the number of distinct columns and noting the attributes that contain a one (1) for the number of distinct columns. If there are attributes containing constant data, the illustrated method continues to Block 324 wherein a quality tag is created to describe the constant attribute with the common status “SI” and the preferred type “Constant.” If there are attributes for which there are multiple data values at Block 322, or after the appropriate quality tags have been created at Block 324, the illustrated method continues to the cross-reference indicator A and from there to FIG. 3B.

FIG. 3B continues the illustrated preferred method of metadata analysis beginning at cross-reference indicator A and continuing to Block 326 wherein data samples are imported and the keys are defined. From Block 326 the illustrated method continues to Block 328 wherein the key structure is analyzed to determine whether the documented key structure supports the data. If the documented key structure does not support the data, the illustrated method continues to Block 330 wherein a quality tag is created with the common status “SI” and the preferred type “Key Structure.”

If the documented key structure supports the data at Block 328, or after appropriate quality tags are created at Block 330, the illustrated method continues to Block 332 wherein it is determined whether referential integrity is a consideration. Relational tables often contain parent-child relationships between tables. Whether there is a primary/foreign key between tables or lookup tables for codes, a parent-child relationship often exists in a normalized database. There are also times when similar relationships can exist between files. If the metadata documents this type of relationship and the appropriate relations exist in the catalog, then the redundancy profiler or orphan analysis can be used to validate the relationship. If it is determined at Block 332 that referential integrity is a consideration, the illustrated method continues to Block 334 wherein orphan analysis is conducted.

Once orphan analysis has been conducted at Block 334, the illustrated method continues to Block 338 wherein it is determined if there are any orphans present. If orphans are present at Block 338, quality tags with the common status “SI” and the preferred type “Referential Integrity” can be created if there are one or more identified in the child's total orphan rows. If there is cause to indicate missing lookup values in the parent relation, however, it should be considered a data level problem rather than a referential integrity problem. The preferred quality tag type would be “Invalid Lookup Values” for such parent problems. The illustrated method ends at Block 344 once quality tags are created at block 340.

If it is determined that referential integrity is not a consideration at Block 332, or if there are no orphans present at Block 338, the illustrated method continues to Block 336 wherein it is determined whether there were any quality tags created during metadata analysis 300. If the answer at Block 336 is no, then the illustrated method continues to Block 342 wherein a quality tag is created with the status “SI” and the preferred type “Metadata Reviewed” to indicate that no metadata problems were identified. If the answer at Block 336 is yes, or once a quality tag is created at Block 342, the illustrated metadata analysis method ends at block 344.

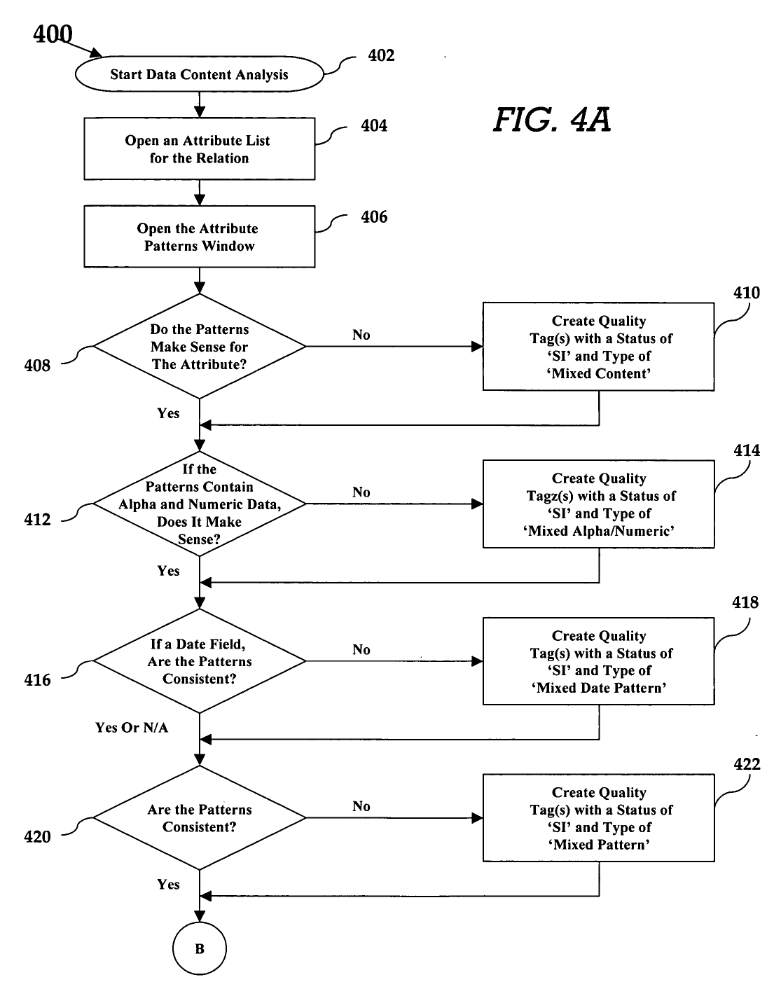

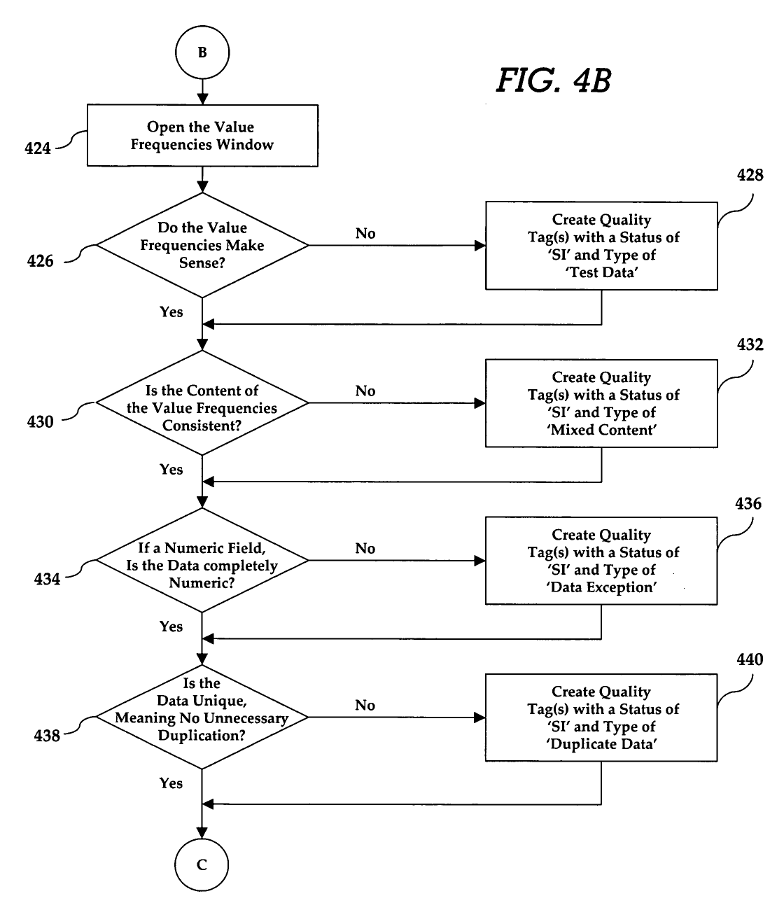

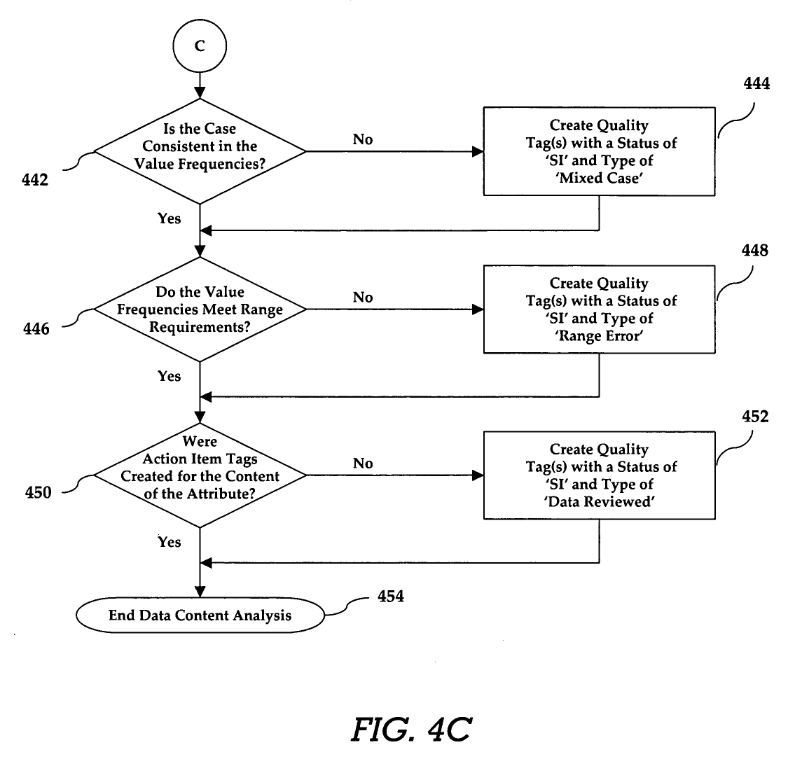

FIGS. 4A, 4B and 4C are flow chart diagrams illustrating a preferred method of conducting data content analysis 400. The data quality content analysis performed as an aspect of the preferred embodiment is intended to identify basic data quality problems. In the methodology of the preferred embodiment, several aspects of the data content are specifically reviewed and any problems found are noted with the preferred quality tags listed in the table above. The preferred data quality types can be generally categorized into two groups, attribute patterns and value frequencies. Blocks 408 through 422 in FIG. 4A relate to analysis of attribute patterns. Blocks 424 through 448 in FIGS. 4B and 4C relate to analysis of value frequencies. It is not necessary that the specific data content aspects be reviewed in the order in which they are described in FIGS. 4A, 4B and 4C, although it is preferable to look first in the attribute patterns to identify possible problems with the data content. Additionally, it is appropriate to indicate the need for additional analysis in the quality tags created as part of the data content analysis of the present invention if such analysis appears to be needed.

The data quality analysis starts in FIG. 4A at Block 402 and continues to Block 404 wherein an attribute list is opened and then continues to Block 406 wherein the attribute patterns window is opened. Once the attribute patterns window is opened in Block 406, the illustrated method continues to Block 408 wherein a determination is made as to whether the patterns make sense for the attribute in question. If the answer in Block 408 is no then the illustrated method continues to Block 410 wherein a quality tag is created with the common status “SI” and the preferred type “Mixed Content.”

If the patterns do make sense for the attribute in Block 408, or after the appropriate quality tag is created in Block 410, the illustrated method continues to Block 412 wherein it is determined whether attribute patterns identified as having mixed alpha and numeric data make sense. The name of an attribute as well as the documented and inferred data types can provide valuable information in making this determination. For example, the attribute name “ORDER NO” would lead one to believe that the data contains numeric values or a combination of alpha and numeric data. If the accompanying documented data type is integer and the inferred data type is character, it indicates that there will be some unexpected alpha characters in some of the data and patterns. If it is found that there are mixed alpha and numeric data patterns that do not make sense for certain attributes, the illustrated method continues to Block 414 wherein a quality tag is created with the common status “SI” and the preferred type “Mixed Alpha/Numeric.”

If any instances of mixed alpha and numeric data do make sense at Block 412, or after the appropriate quality tags are created at Block 414, the illustrated method continues to Block 416 wherein it is determined whether there are mixed date patterns in the data. Specifically identifying mixed date patterns separately from other types of mixed patterns is preferred because dates are an often used attribute. For example, if the attribute is “ORDER_DATE,” there may be a mixture of date patterns in the data such as: 01/01/01, 1/1/01, 01/01/2001, 1/1/2001, 01-Jan-01, 1-Jan-01 and 01-Jan-2001. If there are date fields for which the date pattern is not consistent, the illustrated method continues to Block 418 wherein a quality tag is created with the common status “SI” and the preferred type “Mixed Date Pattern.”

If there are no date fields or there are no date fields with inconsistent date patterns in Block 416, or after appropriate quality tags are created in Block 418, the illustrated method continues to Block 420 wherein data patterns other than date patterns are analyzed to determine whether they are consistent. If there are date patterns that are not consistent, the illustrated method continues to Block 422 wherein a quality tag is created with the common status “SI” and the preferred type “Mixed Pattern.” If the data patterns are consistent at Block 420, or after any inconsistent data patterns are identified at Block 422, the illustrated method continues to cross-reference indicator B and then on to FIG. 4B.

FIG. 4B is a continuation of the flow chart diagram illustrating a preferred method of performing data content analysis. FIG. 4B begins at cross-reference indicator B and continues to Block 424 wherein the value frequencies window is opened. Once the value frequencies window is opened at Block 424, the illustrated method continues to Block 426 wherein it is determined whether the value frequencies make sense. If the value frequencies do not make sense, there is most likely test or garbage data, and the illustrated method continues to Block 428. For example, test or garbage data is usually obvious, such as an address attribute containing nothing but “XXX.” At Block 428 quality tags are created with the common status “SI” and the preferred type “Test Data” to identify test or garbage data.

If the value frequencies make sense at Block 426, or after the appropriate quality tags are created identifying test or garbage data at Block 428, the illustrated method continues to Block 430 wherein it is determined whether the content of the value frequencies is consistent. If, for example, an attribute like an address contains address data, but also includes value frequencies of dollar amounts, then there is mixed data content. If the content of the value frequencies is not consistent, the illustrated method continues to Block 432 wherein a quality tag is created with the common status “SI” and the preferred type “Mixed Content.”

If the content value frequencies are consistent at Block 430, or after inconsistent value frequencies are identified at Block 432, the illustrated method continues to Block 434 wherein it is determined whether the data is completely numeric in any numeric data fields. When an attribute that should be numeric contains alpha data, a data exception would occur if the data were moved into a numeric field or used in a calculation. If there are numeric data fields for which the data is not completely numeric, the illustrated method continues to Block 436 wherein quality tags are created with the common status “SI” and the preferred type “Data Exception.”

If there are no numeric fields for which the data is not completely numeric at Block 434, or after appropriate quality tags are created at Block 436, the illustrated method continues to Block 438 wherein it is determined whether the data is unique and there are no unnecessary duplications of data. Duplicate data is data that should be consolidated. If the data is not unique and there is unnecessary duplication of data, the illustrated method continues to Block 440 wherein quality tags are created with the common status “SI” and the preferred type “Duplicate Data.”

If the data is unique and there is no identified unnecessary duplication of data at Block 343, or after appropriate quality tags are created at Block 440, the illustrated method continues to cross-reference indicator C and then on to FIG. 4C.

FIG. 4C is a continuation of the flow chart diagram illustrating a preferred method of performing data content analysis. FIG. 4C begins at cross-reference indicator C and continues to Block 442 wherein it is determined whether the case is consistent in the value frequencies. Mixed case data would result from inconsistent capitalization between data entries. If the case is not consistent in the value frequencies, the illustrated method continues on to Block 444 wherein quality tags are created with the common status “SI” and the preferred type “Mixed Case.”

If the case is consistent in the value frequencies at Block 442, or after appropriate quality tags are created at Block 444, the illustrated method continues to Block 446 wherein it is determined whether the value frequencies meet the associated range requirements. An example of data that does not meet the associated range requirements for the attribute might be a gender indicator that includes “M,” “F,” and “A.” The “A” is not a typical gender indicator. If there is data for which the value frequencies do not meet the range requirements, the illustrated method continues on to Block 448 wherein quality tags are created with the common status “SI” and the preferred type “Range Error.”

If the value frequencies do meet the range requirements at Block 446, or after appropriate quality tags are created at Block 448, the illustrated method continues to Block 450 wherein it is determined whether any qualities tags were created during the data content analysis. If no data quality problems are identified during the data content analysis, the illustrated preferred method continues to Block 452 wherein a quality tag with the common status “SI” and the preferred type “Data Reviewed” is created to indicate that there were no obvious data quality problems found. If it is determined at Block 450 that there were quality tags created during the data content analysis, or after the appropriate quality tag is created at Block 452, the illustrated method of data content analysis ends at Block 454.

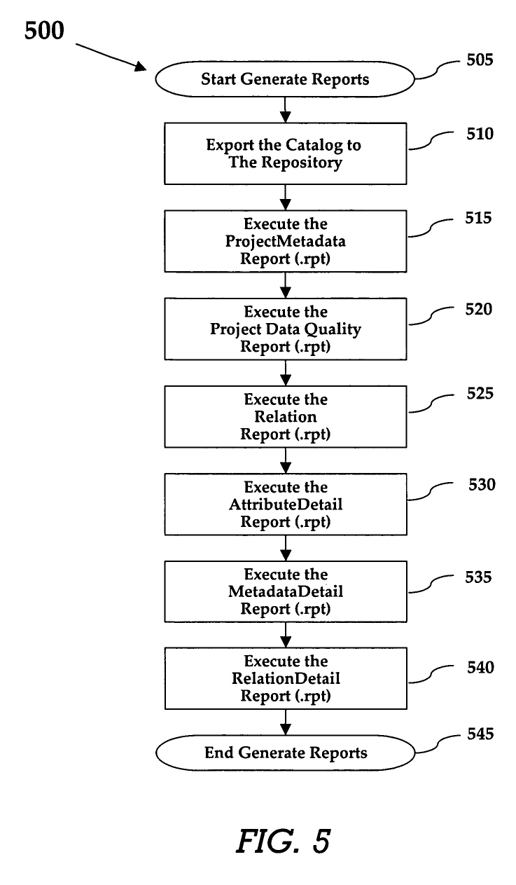

FIG. 5 is a flow chart diagram 500 illustrating a preferred method of generating reports to provide the results of the analysis performed and the problems identified. The preferred method of generating reports starts at Block 505 and continues to Block 510 wherein the catalog created for the data quality analysis is exported to the repository (a relational database). A repository will be a component of the Data Profiling software with which this invention is intended to be used. Reports can then be run against the repository to detail specific projects and relations or contain all projects and relations containing quality tags of the same status.

As illustrated in FIG. 5, there are six reports that may be created as part of the preferred embodiment of the present invention. It is not necessary that the preferred reports be executed in the order in which they are illustrated in FIG. 5. Two of the preferred reports are a project metadata report and a project data quality report which, respectively, provide an overview of the file and metadata problems and of the data quality problems identified across an entire project. Block 515 illustrates execution of the project metadata report. Block 520 illustrates execution of the project data quality report. Another preferred report is illustrated as being executed in Block 525, it is a relational report which provides a summary of the number of data quality, metadata, and file problems found for specific relations. The fourth preferred report is illustrated as being executed in Block 530, it is an attribute detail report which provides the detailed information stored in the text of the quality tags created for each attribute. A fifth preferred report is illustrated as being executed at Block 535, it is a metadata detail report which provides the detailed information stored in the text of the quality tags created for each attribute with metadata problems. The sixth preferred report is illustrated as being executed at Block 540, it is a relation detail report which provides the detailed information stored in the text of the quality tags created at the relation level identifying format problems. Once the preferred reports are executed, the illustrated method of generating reports ends at Block 545.

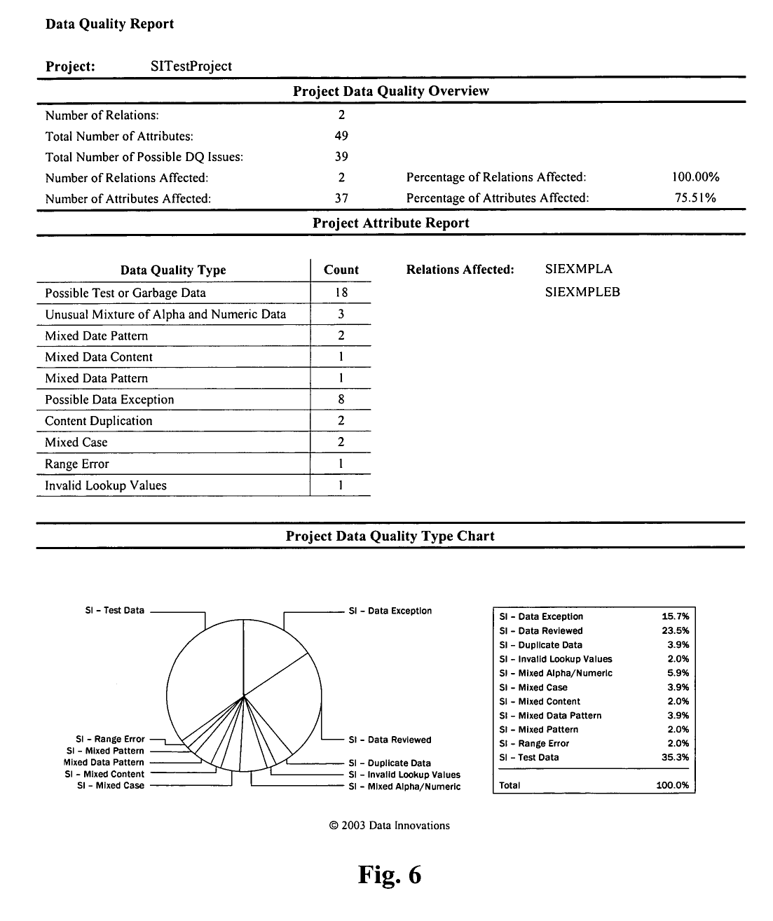

FIG. 6 is one embodiment of a project data quality report, containing sample information, formatted to provide an overview of the data quality problems identified across an entire project. There are three sections in the preferred project data quality report illustrated in FIG. 6. The sections are entitled Project Data Quality Overview, Project Attribute Report, and Project Data Quality Type Chart. Within the three sections illustrated, information regarding the problems identified with quality tags during data level quality analysis is summarized in both tabular and graphical form. The Project Data Quality Overview section illustrated in FIG. 6 includes information regarding the number of relations, the total number of attributes, the total number of possible data quality issues, the number of relations affected, the number of attributes affected, the percentage of relations affected, and the percentage of attributes affected. The preferred Project Attribute Report Section illustrated includes a two column table. The first column lists the quality tag types associated with data level analysis and the second column provides the number of each type of problem identified. The Project Data Quality Type Chart section illustrated includes a pie chart showing the proportional amount of problems identified by type as classified in the quality tags associated with data level analysis. The pie chart may be in black and white, as shown, or may include color coding. The Project Data Quality Type Chart section illustrated also includes a table listing a percentage breakdown of problems identified by type as classified in the quality tags associated with data level analysis.

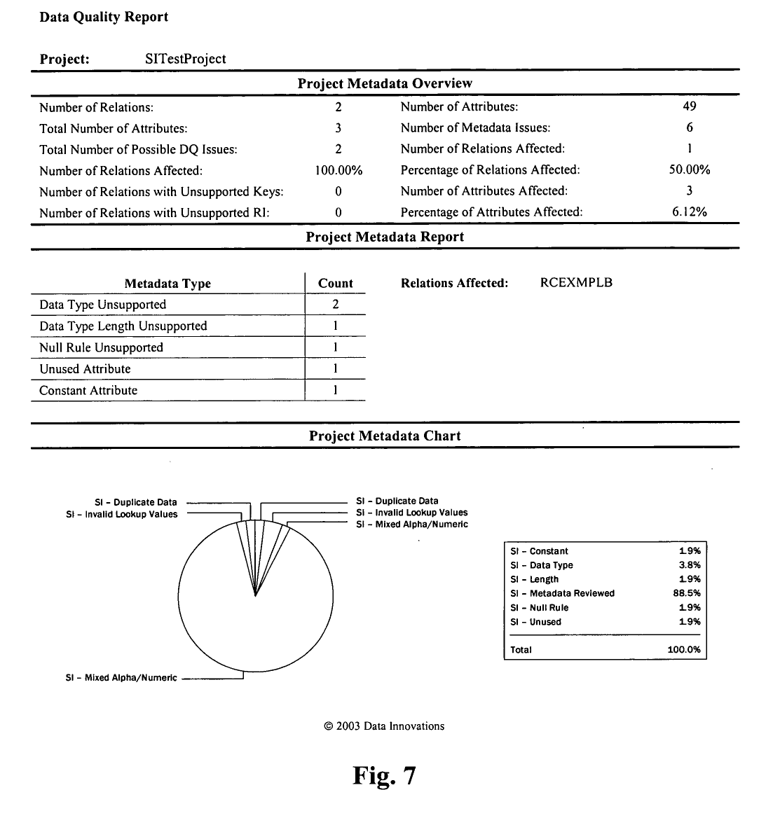

FIG. 7 is one embodiment of a project metadata report, containing sample information, formatted to provide an overview of the file and metadata problems across an entire project. There are three sections in the preferred project metadata report illustrated in FIG. 7. The sections are entitled Project Metadata Overview, Project Metadata Report, and Project Metadata Chart. Within the three sections illustrated, information regarding the problems identified with quality tags during metadata quality analysis is summarized in both tabular and graphical form. The preferred Project Metadata Overview section illustrated includes information regarding the number of relations, the number of record format problems, the number of relations affected by record format problems, the percentage of relations affected by record format problems, the number of relations with unsupported keys, the number of relations with unsupported referential integrity, the number of attributes, the number of metadata issues, the number of relations affected by metadata issues, the percentage of relations affected by metadata issues, the number of attributes affected by metadata issues, and the percentage of attributes affected by metadata issues. The preferred Project Metadata Report illustrated in FIG. 7 includes a two column table. The first column lists the quality tag types associated with metadata level analysis and the second column provides the number of each type of problem identified. The preferred project Metadata Chart section illustrated includes a pie chart showing the proportional amount of problems identified by type as classified in the quality tags associated with metadata level analysis. The pie chart may be in black and white, as shown, or may include color coding. The preferred Metadata Chart section illustrated also includes a table listing a percentage breakdown of problems identified by type as classified in the quality tags associated with metadata level analysis.

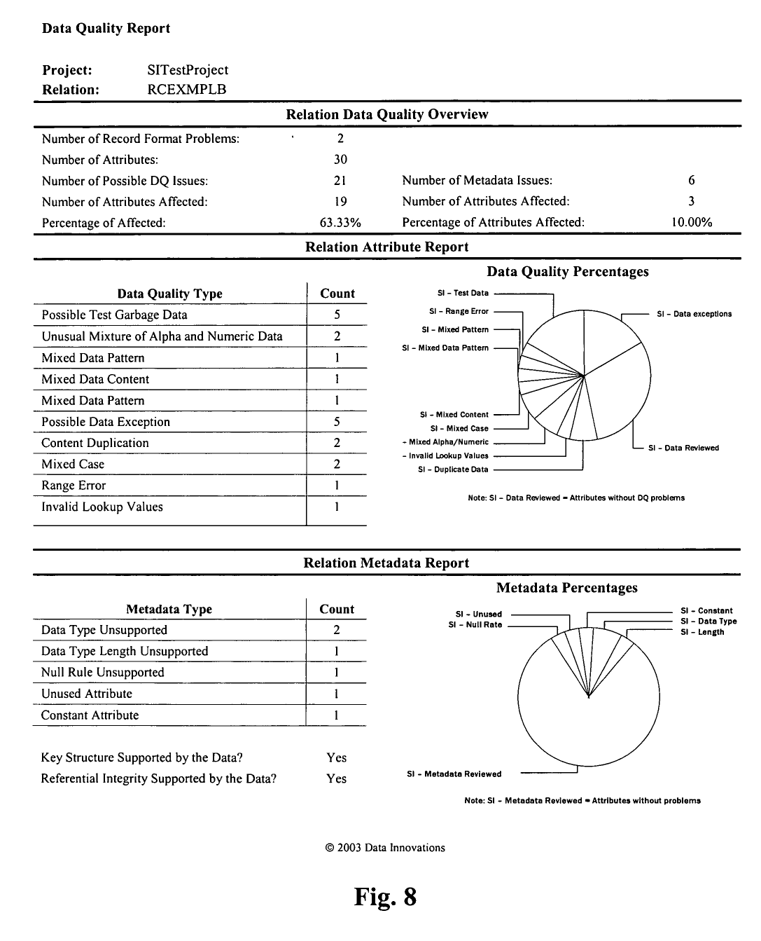

FIG. 8 is one embodiment of a relational report, containing sample information, which provides a summary of the number of data quality, metadata, and file problems found for specific relations. There are three sections in the preferred relational report illustrated. The sections are entitled Relation data Quality Overview, Relation Attribute Report, and Relation Metadata Report. The preferred Relation Data Quality Overview section illustrated includes information regarding the number of record format problems, the number of attributes, the number of possible data quality issues, the number of attributes affected by the possible data quality issues, the percentage of attributes affected by the possible data quality issues, the number of metadata issues, the number of attributes affected by metadata issues, and the percentage of attributes affected by metadata issues. The preferred Relation Attribute Report illustrated includes a two column table listing the number of problems identified for each quality tag type associated with data level analysis. The preferred Relation Attribute Report illustrated also includes a pie chart showing the proportional amount of problems identified by type as classified in the quality tags associated with data level analysis. The preferred Relation Metadata Report section illustrated includes a two column table listing the number of problems identified for each quality tag type associated with metadata level analysis. The preferred Relation Metadata Report illustrated also includes a pie chart showing the proportional amount of problems identified by type as classified in the quality tags associated with metadata level analysis. The pie charts may be in black and white, as shown, or may include color coding.

In addition to the reports illustrated in FIGS. 6, 7 and 8, the other three reports illustrated as being executed in FIG. 5 as part of the preferred embodiment of the present invention include an attribute detail report, a metadata detail report, and a relational detail report. The preferred embodiment of an attribute detail report includes a three column table. The first column preferably lists the attributes. The second column preferably lists the corresponding quality tag types associated with data level analysis for which there were problems identified during analysis. The third column preferably lists the corresponding content of each quality tag for which there were problems identified during data level analysis.

The preferred embodiment of a metadata detail report also includes a three column table. The first column preferably lists the attributes. The second column preferably lists the corresponding quality tag types associated with metadata level analysis for which there were problems identified during analysis. The third column preferably lists the corresponding content of each quality tag for which there were problems identified during metadata level analysis.

The preferred embodiment of a relation detail report includes a two column table. The first column preferably lists the quality tag types associated with relation level analysis for which there were problems identified during analysis. The second column preferably lists the corresponding content of each quality tag for which there were problems identified during relation level analysis.

The above discussion provides only some examples of available embodiments of the present invention. Although the preferred embodiment of the present invention is intended for use with Evoke Axio Product Suite™, the invention is not limited to such use. The present invention could be used with any data profiling, data analysis, or ETL (Extract, Transform, Load) software with slight modifications to the components that would be obvious to one of ordinary skill in the art. Further, the invention could be integrated or coded into data profiling, data analysis or ETL software to be completely independent. The invention could also be integrated or coded into an RDBMS to perform data quality assessments from within a relational database. Those skilled in the art will readily observe that numerous other modifications and alterations may be made without departing from the spirit and scope of the invention. Accordingly, the above disclosure is not intended as limiting and the appended claims are to be interpreted as encompassing the entire scope of the invention.

1. A method of analyzing data quality comprising the steps of:
profiling source data;
performing metadata level analysis and creating quality tags to identify problems with metadata;
performing data content level analysis and creating quality tags to identify problems with data;
generating at least one report describing at least a portion of the identified metadata and data problems.

2. The method of claim 1 wherein the source data comprises at least one of a flat file source and a relational file source.

3. The method of claim 1 wherein each quality tag created comprises a common status.

4. The method of claim 3 wherein each quality tag created further comprises a type describing the category of an identified problem.

5. The method of claim 4 wherein each quality tag created further comprises information indicating at least one of: who created the tag, the date and time the tag was created, a description of the problem found, and example data.

6. The method of claim 1 wherein performing metadata level analysis comprises performing relation level analysis prior to performing analysis on other aspects of metadata.

7. The method of claim 6 wherein performing relation level analysis comprises identifying inconsistencies with record formatting and encoding.

8. The method of claim 6 wherein performing analysis on other aspects of metadata comprises determining at least one of:
whether the data supports the identified key structure,
whether the data supports the expected referential integrity,
whether the null rule is supported by the data,
whether the data supports the documented data type,
whether there is unsupported length associated with a data type,
whether there are unused attributes, and
whether there are constant attributes.

9. The method of claim 1 wherein performing data content level analysis comprises determining at least one of:
whether there is test or garbage data,
whether there is an unusual mixture of alpha and numeric data,
whether there are multiple date patterns in a date field,
whether there are unusual or inconsistent patterns for an attribute,
whether data contains content with different meanings,
whether there is data that may cause a data exception when used in other programs,
whether there is duplicate data,
whether there is inconsistent use of case in the data,
whether there is data that is out if range for an attribute, and
whether there are invalid lookup values.

10. The method of claim 1 wherein generating at least one report comprises exporting information contained in the quality tags to a repository and executing report generation commands to generate said at least one report based upon the quality tags.

11. The method of claim 10 wherein a report is generated that provides an overview of the file and metadata problems identified across an entire project.

12. The method of claim 10 wherein a report is generated that provides an overview of the data quality problems identified across an entire project.

13. The method of claim 10 wherein a report is generated that provides a summary of the number of data quality, metadata, and file problems found for specific relations.

14. The method of claim 10 wherein a report is generated that provides the detailed information stored in the text of any quality tags created for each attribute.

15. The method of claim 10 wherein a report is generated that provides the detailed information stored in the text of any quality tags created for each attribute with metadata problems.

16. The method of claim 10 wherein a report is generated that provides the detailed information stored in the text of any quality tags created at the relation level identifying format problems.

17. A method for analyzing data quality for a given set of source data, the method comprising:
a. profiling source data;
b. performing relation analysis comprising:
i. creating a catalog;
ii. importing metadata into the catalog from a file characterized by a file structure and a file encoding;
iii. comparing the source data with the file structure and noting inconsistencies with at least one quality tag; and
iv. comparing the source data with the file encoding and noting inconsistencies with at least one quality tag;
c. performing metadata analysis comprising:
i. opening an attribute list for the source data; and
ii. comparing the attribute list to the metadata and noting inconsistencies with at least one quality tag;
d. performing data content analysis comprising:
i. opening an attribute list for the source data;
ii. reviewing source data patterns and noting data pattern inconsistencies with at least one quality tag; and
iii. reviewing the source data values and noting inconsistencies with at least one quality tag;
e. generating reports comprising:
i. exporting the catalog to a repository; and
ii. executing report generation commands.
